(19) United States
(12) Patent Application Publication
(10) Pub. No.: US 2010/0229454 A1
(43) Pub. Date: Sep. 16, 2010

(54) RATTLING WEIGHT FOR FISHING BAITS

(75) Inventor: Roy Daniel Cunningham, Columbus, MS (US)

Correspondence Address: BRADLEY ARANT BOULT CUMMINGS LLP, 200 CLINTON AVE. WEST, SUITE 900, HUNTSVILLE, AL, 35801, US

(73) Assignee: Southern Lure Company, Columbus, MS (US)

(21) Appl. No.: 12/582,785

(22) Filed: Oct. 21, 2009

Related U.S. Application Data
(63) Continuation-in-part of application No. 12/401,882, filed on Mar. 11, 2009.

(51) Int. Cl. A01K 85/01

(52) U.S. Cl. 43/42.31; 43/42.39

(57) ABSTRACT

A rattle is intended to be used with a fishing bait. The rattle includes a perforated case with a ringer inside the case. The ringer contacts the interior of the case and produces sound as the fishing bait moves. The case is enveloped in a wrap.

This application is a continuation in part and claims priority to U.S. patent application Ser. No. 12/401,882 titled JIG HEAD WITH A RATTLE, which was filed on Mar. 11, 2009.

### BACKGROUND OF THE INVENTION

a. Field of the Invention

The current invention relates to baits used for fishing.

b. Background of the Invention

Many different types of bait are used for fishing. A jig is one type of bait available. The jig typically includes two primary portions. The first portion is the jig head and hook and the second portion is the body. The body is often a soft material, such as silicone, rubber, hair, or other materials, and it is normally flexible so it can move and “wiggle” as the jig passes through water. The wiggling soft body can imitate a fish food source, such as a worm, frog, crawfish, minnow, or other creature. The wiggling motion tends to make the jig appear alive to the fish. The fishing line is typically connected to the jig head such that the softer body trails behind the jig head when the fisherman using the jig as bait reels in the fishing line.

The jig head is typically, but not always, made of lead and weighted such that it sinks in the water. Jigs are often fished using a vertical type motion where the jig head falls to the bottom of the water body, such as to the river bed or the bed of a pond, with the softer body trailing behind. The fisherman then jerks on the line, which causes the jig head to bounce upwards and off the bottom of the water body. The fisherman then relaxes the line so the jig head drifts back downwards. This motion is repeated at various rates so it looks like the jig is bouncing along the bottom. This could simulate an animal moving along the bottom of the water body.

Jigs can also be fished in other manners, including more horizontal motions. The fisherman can also stop or slow the reeling motion periodically, so the jig starts to sink until the reeling starts again. This produces a jig motion which is primarily horizontal, with occasional dips and rises providing some vertical elements to the jig motion. There are many other techniques that can be used when fishing with a jig, and some jigs are better adapted for different applications.

Typically, the jig head will include a hook and the soft body is connected to the jig head with the hook. In some embodiments, the soft body is pierced by the hook near the front, and the hook is worked through the soft body a short distance before exiting. The portion of the soft body first pierced by the hook is normally positioned along the hook shank adjacent the jig head, and the portion of the soft body containing the hook shank tends to guide the soft body to trail after the jig head. In other embodiments, the soft body might be a skirt which hangs around the hook but is secured adjacent to the jig head.

Many other types of baits are available for a fisherman to choose from. Some examples include crank baits, hard baits, blade baits, topwater baits, swim baits, stick baits, lipless baits, spinner baits, buzz baits, inline spinners, spoons, and others. Many baits are cast out and then reeled in to simulate something a fish would like to eat. Fish have a varied diet, so many different things can be simulated. Some baits remain primarily on top of the water, other baits tend to move under the surface at varying depths, and others tend to remain near the floor of the water body. The motion of different baits through the water varies, including some travelling in an up and down motion, others moving side to side or around in circles, and others spinning as the bait travels through the water. Fishing techniques have an effect on the motion of different baits through the water as well.

Baits come in a wide variety of colors, shapes, sizes, weights, and configurations. Often one portion of a bait will be one color and another portion will be a different color. The bait can include various designs such as artificial eyes, stripes, polka dots, and varying hook designs and locations. The bait can include a wide variety of shapes. It can be shaped to appear like a frog or a crawfish, it can include a long slender body like a worm with segmentations, it can be shaped like a minnow or small fish, or it can have other shapes that attract fish. The bait can include a multitude of dangling arms, fingers, or frills, and the bait can be split into more than one component with a wire, string or other device connecting the different components. A great variety of different appearances are possible.

Other methods used to attract fish or enhance the effectiveness of various types of fishing baits include rattles. Rattles are incorporated into a number of different types of baits, often consisting of BBs incorporated into a hollow body. As the bait is retrieved, it can result in a side to side “waggle” motion causing the bait to rattle. Baits can also include many other devices to improve the attractiveness of the bait to a fish, such as pork scents, attached bait fish, or glow in the dark components. People who fish like to try a wide variety of baits, and are often seeking to improve their fishing technique and tackle.

### BRIEF SUMMARY OF THE INVENTION

A rattle for use with fishing baits includes a ringer positioned within a case. The case is rigid and perforated, and a wrap envelopes the case. The ringer contacts the interior of the case and produces sound as the fishing bait moves.

### BRIEF DESCRIPTION OF THE SEVERAL VIEWS OF THE DRAWINGS

FIG. 1 is a side view of a jig, which is one type of a fishing bait.

FIG. 2 is a side view of a fishing bait with the housing sectioned and shown in dashed lines.

FIG. 3 is a cross sectional side view of a one embodiment of rattle with the ringer inside.

FIG. 4 is a side view of an alternate embodiment of a rattle with the ringers shown in dashed lines.

FIG. 5 is side view of an alternate embodiment of a fishing bait with the housing sectioned and shown in dashed lines.

FIG. 6 is a side view of another embodiment of a fishing bait with the housing sectioned and shown in dashed lines.

FIG. 7 is a side view of yet another embodiment of a fishing bait with the housing sectioned and shown in dashed lines.

FIG. 8 is a side view of still another embodiment of a fishing bait with the components within the housing shown in dashed lines.

FIG. 9 is a side view of another embodiment of a fishing bait with the components within the housing shown in dashed lines.

FIG. 10 is a top perspective view of one more embodiment of a fishing bait resembling a frog where the rattle inside the housing is shown in dashed lines.

FIG. 11 is a side view of a soft body shaped like a worm, with the rattle inside.

### DETAILED DESCRIPTION

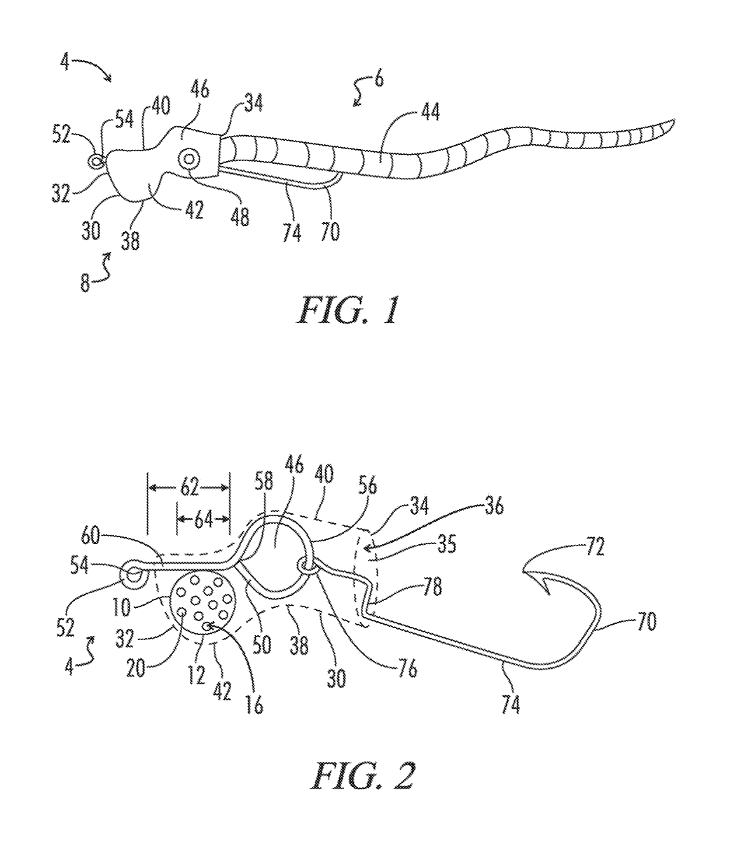

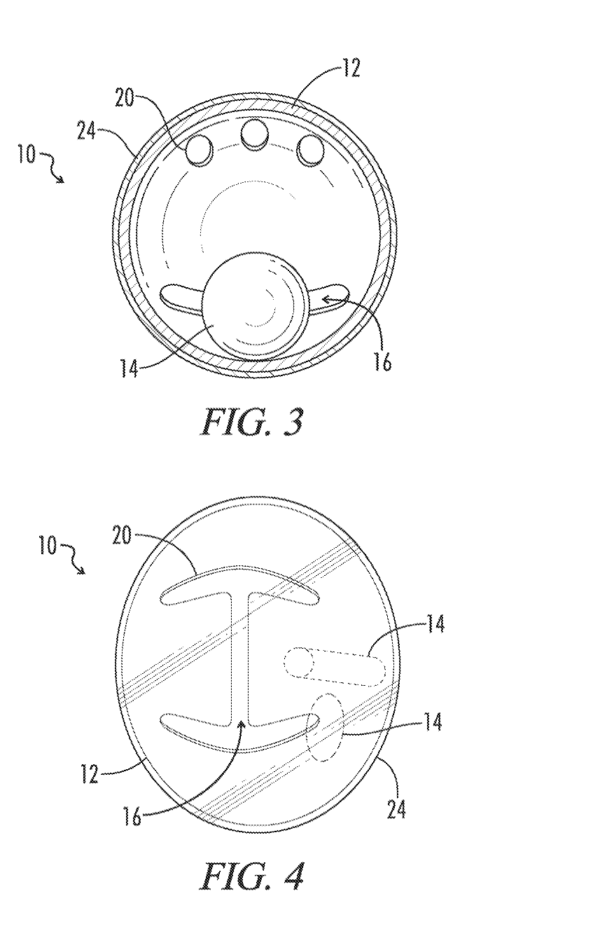

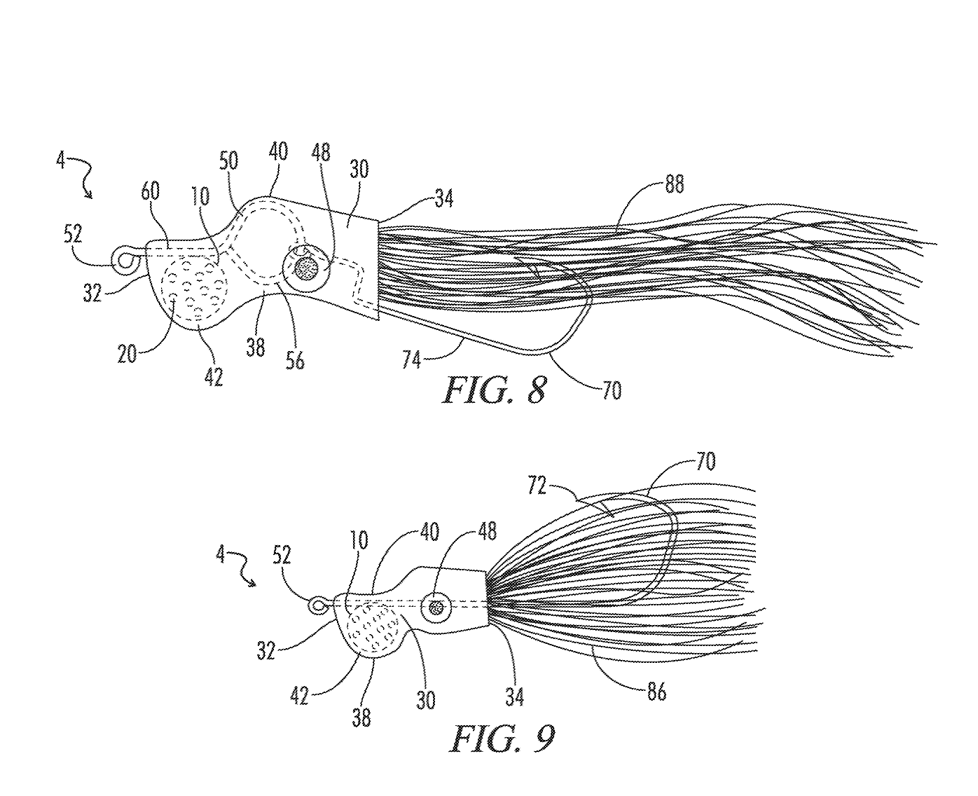

There are many types of fishing baits 4 available to a fisherman, some examples of which are shown in FIGS. 1-10. These include, but are not limited to, crank baits, hard baits, blade baits, topwater baits, swim baits, stick baits, lipless baits, spinner baits, buzz baits, inline spinners, and spoons. A jig 6 is one type of fishing bait. The jig 6 has a jig head 8, which is often weighted, and dives towards the floor of the body of water when the attached fishing line is allowed to go slack. Other fishing baits 4 are used near or on the water surface, such as topwater baits. Topwater baits typically float, and can be reeled in by the fisherman such that the bait motion simulates known fish prey. Different types of fishing baits 4 have different characteristics, shapes, and functions. The term fishing bait 4 includes many different sub-categories of fishing bait 4, such as jigs 6 and topwater baits. The fishing bait 4 in this description has several components, including a rattle, a housing, and can include a hook.

A jig 6 is one type of fishing bait 4. A jig 6 used for fishing includes a jig head 8 and an attached soft body 44, as shown in FIG. 1. It should be noted that the jig 6 disclosed in FIG. 1 is only one type of jig, and many other embodiments are known to those of skill in the art. In use, a fishing line is attached to the jig head 8, and the soft body 44 trails behind. The soft body 44 can take a wide variety of forms and shapes. The jig head 8 can also be used without a separate soft body 44.

### Rattle

A rattle 10 can be used in the fishing bait 4. The rattle 10 includes a case 12, a ringer 14, and a wrap 24, as seen in FIGS. 2, 3, and 4, with continuing reference to FIG. 1. The case 12 has an interior 16 and the ringer 14 is positioned inside the case interior 16. The ringer 14 moves about within the case 12 and impacts the walls of the case interior 16. The impact of the ringer 14 contacting the walls of the case interior 16 produces a sound. As the ringer 14 bounces back and forth it makes a rattling sound from repeated contact between the ringer 14 and the walls of the case interior 16.

The ringer 14 can be round like a ball, or it can be a cylinder, or it can be three-dimensional star, or it can be any of a wide variety of shapes. The ringer 14 has to have a volume which is less than the volume of the case interior 16 because the ringer 14 needs to move within the case 12 to cause the rattling sound. The case 12 can also have a wide variety of shapes, such as a sphere, an oblong shape like a rugby ball, or any of a wide variety of shapes which allow the ringer 14 to move within the case interior 16. The case 12 can be of unitary construction where the case 12 is formed from one single piece, such as by bending sheet metal to a desired shape or forming a single polymeric piece. This provides a case 12 that is one piece. The case 12 can also be formed by connecting two or more pieces, such as with an adhesive or threads, so the case 12 can have a plurality of pieces.

There can be more than one ringer 14, where the ringers 14 would make sound when impacting the walls of the case interior 16 as well as when the ringers 14 contacted each other. If there is more than one ringer 14, the ringers 14 can have different shapes within the same case 12 or there can be a plurality of ringers 14 with the same shape within the case 12.

The ringer 14 should be rigid such that when the ringer contacts the walls of the case interior 16 it makes an impact type noise. The ringer 14 can be made of many materials, including various metals or combinations of metals, ceramic, stone, or polymeric. The ringer 14 could be hollow or solid. The material used in the ringer 14 is not critical as long as the ringer 14 is rigid enough to produce sound waves when impacting the walls of the case interior 16. The case 12 is also preferably rigid, so when the ringer 14 contacts the walls of the case interior 16 it causes an impact sound. The case 12, like the ringer 14, can be metallic, ceramic, polymeric, or constructed of other materials, as long as it is rigid enough to produce sound waves when the ringer 14 impacts the walls of the case interior 16. The ringer 14 and the case 12 can be made from the same material, or the ringer 14 and case 12 can be made from different materials. The use of different materials may simplify the rattle production process by facilitating different sources of raw materials.

The case 12 preferably has one or more perforations 20 which penetrate the walls of the case 12, as opposed to the walls of the case 12 being solid. The case perforations 20 can be round, or they can be long, or they can be almost any other shape. The case perforations 20 should be sized and shaped such that the ringer 14 will not pass through the case perforation 20. This can be accomplished by sizing the case perforations 20 smaller than the ringer 14, or it can be done by pushing the edges of the case perforations close together so the ringer 14 cannot pass through a perforation 20. Shaping and/or sizing the case perforations 20 such that the ringer 14 cannot pass through serves to keep the ringer 14 within the case 12 such that the rattle 10 functions to make noise.

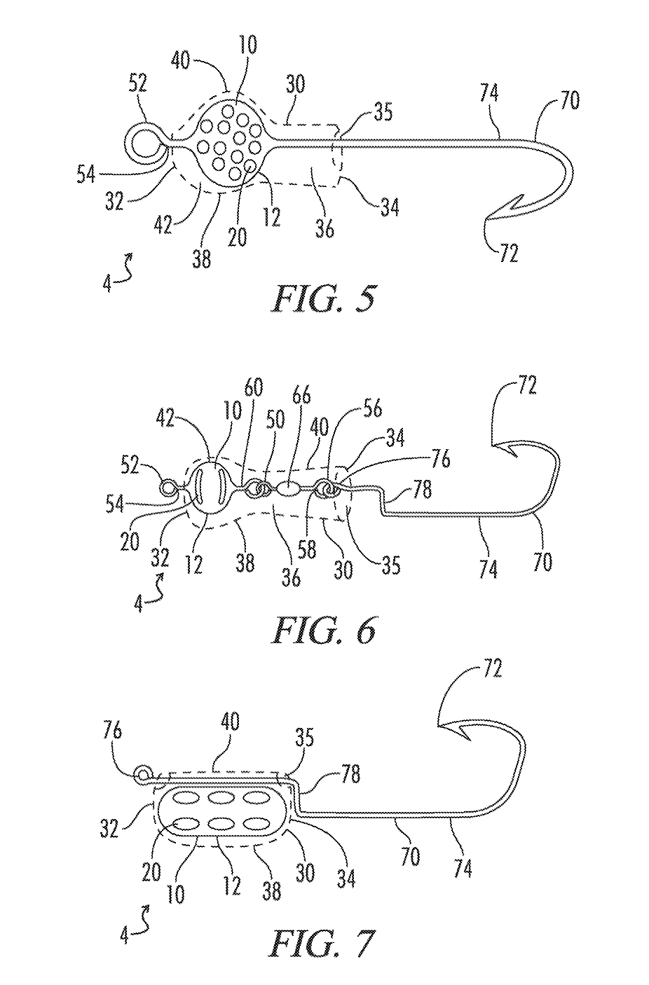

The rattle 10 also preferably includes a wrap 24 which envelopes the case 12. The wrap 24 wraps around the outer surface of the case 12 such that the case 12 is enveloped within the wrap 24. The wrap 24 can be pliable and flexible to facilitate placing the wrap 24 around the case 12. The wrap 24 can be polymeric, a natural fabric, or any of a wide variety of materials. The wrap 24 can form a compression fit around the case 12 so the case 12 is held fast within the wrap 24. Reference is now made to FIG. 5, with continuing reference to FIGS. 1, 2, 3, and 4. The wrap 24 is considered to envelop the case 12 as long as the wrap 24 covers the perforations 20 and a majority of the surface area of the case 12 directly opposite the walls of the case interior 16. The rattle 10 can be a separate element which is incorporated into the fishing bait 4, or the rattle 10 can be integrally formed with the fishing bait 4. If the case 12 includes a projection, such as a hook shank extending directly from the case 12, the wrap 24 can still envelope the case 12 without covering the projection extending from the case 12.

For some case perforation configurations, there is an observable increase in the volume of the rattling sound for a rattle 1.0 using the wrap 24 over a rattle 10 without a wrap 24.

The wrap 24 can seal the case perforations 20, which can help make the rattle 10 substantially waterproof. Keeping the rattle 10 waterproof can be desirable because water dampens the motion of the ringer 14 within the case interior 16, and thereby limits the sound produced by the rattle 10. Referring to the rattle 10 as being substantially waterproof means that the wrap 24 covers the case perforations 20 such that water cannot freely flow into the case interior 16. In some embodiments water may be able to pass through the wrap 24 at a gradual rate. If the rate of water passage through the wrap 24 is slow enough, it may not significantly impede the sound of the rattle 10 and the rattle 10 will still be functional.

The rattle 10, which includes the case 12, the ringer 14, and preferably the wrap 24, can have a density of greater than one gram per cubic centimeter, which is the density of water. With this density, the rattle 10 is heavier than water and can serve as a weight or sinker in the fishing bait 4. A rattle 10 with a density greater than one gram per cubic centimeter becomes a rattling weight 10. The density and weight of the rattle 10 can vary between different fishing baits 4, and different weights and densities can be used to produce different effects for a variety of fishing situations. The density of the rattle 10 is measured when there is no water in the case interior 16. For some rattles 10, a density of less than one gram per cubic centimeter can be achieved, where the rattle 10 will provide buoyancy to the jig head 8. Increasing the weight of the ringer 14 while maintain the size of the case 12 is one way to increase the density of the rattle 10. A rattling weight 10 reduces or eliminates the need for additional weight to be added to the fishing bait 4. Reducing the number of components on the fishing bait 4 can simplify preparing the fishing bait 4 for use, and may have additional benefits such as a different motion of the fishing bait 4 through water.

### Housing

The fishing bait 4 can include a housing 30. The housing 30 can be flexible and can be constructed of rubber, silicone, elastic or any of a wide variety or combination of various materials. In some embodiments the housing is resilient so it retains its shape such that when the housing 30 is squeezed or compressed, the shape can change, but when the compression is removed and the housing 30 is relaxed, it returns to its original shape. In other embodiments, the housing 30 can be rigid. In still other embodiments, the housing 30 can be the soft body 44, where the soft body 44 can be separate from a hook 70, as seen in FIG. 11 with continuing reference to FIGS. 1-4. In the illustrated example, the housing 30 is shaped like a worm, and the case 12 is positioned within the housing 30. The housing 30 can then be connected to a separate hook 70. The housing 30 could be shaped to mimic other fish food sources in variations on this embodiment.

The housing 30 can include several different designs and colors. For example, the housing 30 can include one or more artificial eyes 48 attached to or incorporated into the housing 30. The housing 30 can also include a multitude of other designs such as stripes, feathers, fringes, ruffles, frills, or a variety of other shapes or colors to improve the attractiveness of the housing 30 to fish.

The housing 30 has several different parts. It has a front end 32 and a back end 34. The back end 34 can be open to allow access to a housing interior 36 but the back end can also be closed. If the back end 34 is closed, the housing 30 typically has another opening to allow access to the housing interior 36. The housing 30 has a housing bottom 38 and a housing top 40. The housing 30 may also include a pouch 42 which can hold the rattle 10. In this embodiment, the rattle 10 is positioned within the pouch 42 such that the rattle 10 cannot freely fall from the housing 30. In some embodiments, the pouch 42 forms a compression fit with the rattle 10 such that the pouch 42 restricts movement of the rattle 10 within the housing 30.

In one embodiment, the pouch 42 is positioned in the housing bottom 38. The pouch 42 may also be closer to the front end 32 than the back end 34 of the housing 30. By positioning the pouch 42 and the enclosed rattle 10 on the bottom front portion of a housing 30 used for a jig 6, the motion of the jig head 8 can be made to simulate the natural motion of animals in water. If the rattle 10 serves as a weight positioned in the housing bottom 38 near the front end 32, the front bottom of the housing tends to lead the dive of the jig head 10 towards the bottom of the body of water. This provides a swimming type motion to the jig 6 from the jig head 8. The jig head 8 dives with the jig upright, the jig head 8 pointing downward, and the soft body 44 trailing behind, similar to a natural animal. Different simulated swimming motions can be obtained by placing the pouch 42 in different positions, such as in the middle of the housing 30 top to bottom and front to back, or in the middle of the housing 30 front to back but in the bottom portion of the housing 30.

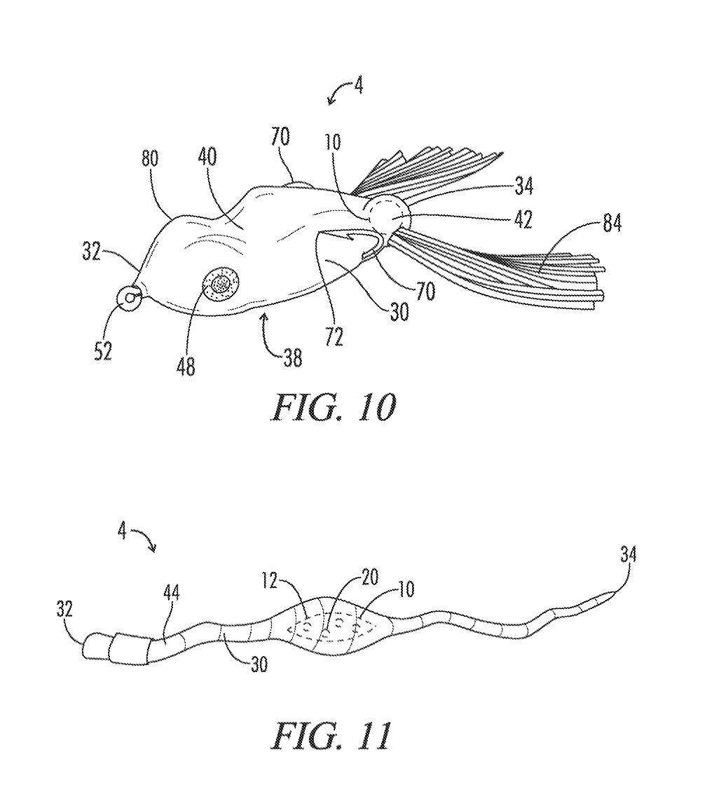

In another embodiment shown in FIG. 10, with continuing reference to FIGS. 1-5, the pouch 42 is located in the housing back end 34. In this embodiment, the housing 30 floats, and the rattle 10 is heavier than water so the housing back end 34 tends to sit lower in the water than the housing front end 32. The housing top 40 includes two eye humps 80 and a body hump 82. The housing 30 is designed to resemble a frog, including the two eye humps 80, the body hump 82, and the coloration and overall shape of the housing 30. Two legs 84 can also be attached to the housing 30 to increase the resemblance of the fishing bait 4 to a frog. In this context, “legs” 84 are any type of appendages designed to simulate legs, but not necessarily in the shape of legs. The eye humps 80 can include artificial eyes 48. The fishing bait 4 can include two hooks 70 positioned on opposite sides of the housing 30. A line loop 52 can protrude from the housing front end 32 for connecting the fishing bait 4 to a fishing pole. The frog bait is a type of topwater bait.

The housing back end 34 can be open so the rattle 10 can be inserted into the housing 30 through the back end 34. In some embodiments the area of the back end opening 35 can be at least one square centimeter. The one square centimeter area provides for a jig head 8 type of fishing bait 4 being larger than certain simulated worms which are used as the soft body 44 with the jig head 8. The area of the back end opening 35 can be less than the cross sectional area of the rattle 10 to aid in keeping the rattle 10 within the housing 30 by resisting passage of the rattle 10 through the back end opening 35.

In one embodiment, the housing 30 can include a vertically oriented portion 46. The vertically oriented portion 46 can be positioned behind the pouch 42 and in front of the back end 34. The housing 30 being constructed of a resilient material can facilitate keeping the vertically oriented portion 46 in the proper shape such that the vertically oriented portion 46 has a longer distance from the housing top 40 to the housing bottom 38 than from side to side. The vertically oriented portion 46 facilitates orientation of a hook, as described below.

### Hook

The hook 70 has several different parts. This includes a hook point 72, a shank 74, a connector 76 and the hook can include a drop 78. In one embodiment, as seen in FIG. 2 with continuing reference to FIGS. 1 and 3-5, the hook connector 76 is connected to a hook loop 56 such that the connector 76 can slide along the hook loop 56. This allows the shank 74 to move horizontally and vertically, but rotational movement of the shank 74 requires the hook loop 56 to rotate. It is possible for the hook 70 to be directly connected to the case 12, as in FIG. 5, and the hook 70 can also be connected to a swivel 66, as in FIG. 6. A swivel 66 allows rotational movement of the hook 70. Other hook connection embodiments are also possible, and would be understood by those of skill in the art.

The hook shank 74 can protrude from the housing 30, and in one embodiment it protrudes from the open back end 34 of the housing 30. It is also possible for the shank 74 to protrude through the housing 30 at other locations, such as through the housing bottom 38, with a small hole in the housing 30 large enough for just the shank 74 to pass through. The hook 70 can also be connected to the fishing bait 4 external to the housing 30. The hook point 72 should be positioned near the housing 30 to facilitate catching fish, such as from contacting the housing 30 to being positioned about 10 centimeters or more from the housing 30. In alternative embodiments which may not include a housing 30, the hook point 72 can be dangled within about 10 centimeters from the rattle 10.

Referring now to FIG. 7, in one embodiment the hook 70 can pass completely through the housing so the hook connector 76 protrudes from the housing front end 32 while the shank protrudes from the housing back end 34. In this embodiment, the hook connector 76 and the shank 74 protrude from different locations on the housing 30. The fishing line could be tied directly to the hook connector 76, and the link 50 (discussed below) would not be needed. Other embodiments are also possible.

The hook 70 can be positioned such that the point 72 is above the shank 74, as seen in FIG. 2 with further reference to FIGS. 1 and 3-6. This positioning can help to minimize the number of weeds caught by the hook 70 when fishing, and it can also tend to conceal the hook 70 along the soft body 44. In one embodiment, the vertically oriented portion 46 urges the hook loop 56 towards a vertical position. When the hook connector 76 is stiff and wrapped around a stiff hook loop 56, rotational movement of the hook 70 requires the hook loop 56 to rotate. The urging force of the vertically oriented portion 46 resists rotation of the hook loop 56, so the rotational position of the hook 70 can be determined, as further described below. In this manner, the hook point 72 can be secured pointing upwards, or in any other orientation desired.

In one embodiment the hook 70 is a drop hook 70, where the shank 74 includes a drop 78. In this embodiment, the straight portion of the shank 74 positioned closer to the point 72 is offset from the portion of the shank 74 positioned in line with the connector 76. The hook 70 can be used to connect the soft body 44 to the jig head 8, and the drop hook 70 can be used such that the soft body 44 is positioned behind the portion of the shank 74 directly in line with the connector 76. This allows for the offset portion of the shank 74, or the straight portion of the shank 74 between the drop 78 and the point 72, to run next to the soft body 44. This can provide for a more controlled angle of the point 72 when catching fish, an improved flow of the fishing bait 4 through the water because the offset portion of the shank 74 is in line with the flow of the fishing bait 4, and better camouflage of the hook 70 against the soft body 44 because the hook 70 is not protruding away from the soft body 44. It is also possible to connect the soft body 44 to a hook 70 without a drop 78.

The hook 70 can have a single point 72, or it can be a treble hook with three points 72, or it can have a different number of points 72 as desired. The hook 70 can be loosely connected within the housing 30 such that the hook 70 dangles from the jig head 8, or the connection can be such that the hook 70 is held fast in one position. In one embodiment, the hook should be positioned relatively close to the housing, typically with the point 72 within no more than 10 centimeters from the housing 30, so fish are more likely to be caught on the hook 70 when attempting to bite the jig 6. However, for larger jigs 6, such as jigs 6 designed for large fish, greater distances may be desired.

### Link

The fishing bait 4 can also include a link 50 in some embodiments. The link 50 serves to connect the fishing bait 4 to a fishing line, or as an attachment point for the hook 70, or both. The link 50 can be stiff enough to maintain its shape, but a soft, flexible link 50 can also be used. The link 50 can be metallic, ceramic, polymeric, fibrous, or any of a wide variety of materials.

In one embodiment, the link 50 includes a line loop 52 which protrudes through the housing 30. The line loop 52 can protrude through the housing 30 at the front end 32, but the line loop 52 can also protrude through the housing 30 at other locations such as the housing top 40 or the housing bottom 38. The position of the line loop 52 will affect the swimming motion of the fishing bait 4, and different positions can be used for different effects.

The line loop 52 is for attaching a fishing line to the fishing bait 4, so the line loop 52 should be large enough to thread a fishing line. In some embodiments, the line loop 52 is relatively small with an inner diameter of between one and five millimeters. The line loop 52 can be larger or smaller, but the relatively small size can minimize visual distraction for a fish looking at the fishing bait 4. The line loop 52 can be completely sealed such that there is no break in the line loop 52, or the line loop 52 can have a break 54. Having a break 54 in the line loop 52 facilitates certain production processes. If the line loop 52 has a break 54, it is preferable that the break 54 be positioned at the back of the line loop 52 to minimize the chance of the fishing line catching or passing through the break 54. The break 54 should also be small to minimize the chance of fishing line passing through the break 54.

The link 50 can also include a hook loop 56 for attaching to a hook 70. The hook loop 56 can be larger than the line loop 52 and can include an inner diameter of between one half to two centimeters. The hook loop 56 can also be larger or smaller as desired. As with the line loop 52, the hook loop 56 can be solid or it can include a hook loop break 58. Having a break 58 in the hook loop 56 can facilitate certain production processes. The hook loop break 58 should be small enough to prevent a hook 70 from disengaging from the hook loop 56.

The link 50 can also include an arm 60 which is positioned between the line loop 52 and the hook loop 56. This arm 60 can have a length 62 which is greater than a rattle diameter 64. This allows the line loop 52 to be positioned in front of the rattle 10 and the hook loop 56 to be positioned behind the rattle 10 with the arm 60 passing alongside or over the rattle 10 as desired. The arm length 62 can also be shorter than the rattle diameter 64. The arm 60 and hook loop 56 can be positioned within the housing 30, with just the line loop 52 protruding out of the housing 30.

The hook loop 56 can be positioned in the vertically oriented portion 46 of the housing 30. By positioning the hook loop 56 in the vertically oriented portion 46, the housing 30 can tend to urge the hook loop 56 into a vertical orientation. The connection of the hook 70 and the hook loop 56 can be such that the orientation of the hook 70 is dictated at least somewhat by the hook loop 56. For example, if the hook 70 includes a stiff connector 76 looped around a stiff hook loop 56, rotational movement of the hook 70 about the hook shank axis can be resisted. Therefore, urging the hook loop 56 into a vertical orientation can advantageously affect the orientation of the hook 70.

The hook loop 56 may be properly sized such that the vertically oriented portion 46 of the housing 30 urges the hook loop 56 towards a vertical orientation. The hook loop 56 can be large enough to contact the top and bottom of the vertically oriented portion 46 such that the hook loop 56 is held in position. The hook loop 56 can be positioned such that it contacts the vertically oriented portion 46 at the housing bottom 38 and the housing top 40 without contacting the sides. It is also possible to design the housing such that the hook loop 56 is contacted by the housing sides.

It is also possible to provide a hook loop 56 which is smaller than the housing 30 such that the hook loop 56 can rotate within the housing 30, as best seen in FIG. 6. This will allow the hook 70 to take various positions, and can be advantageous for certain types of hooks 70 such as treble hooks. The arm 60 can include a swivel 66, which allows rotational movement of the hook. If the arm 60 includes a swivel 66, the hook 70 can be connected to the swivel 66 through a hook loop 56. It is also possible for a swivel 66 to connect the hook 70 and the line loop 52 using fishing line or other materials. In other embodiments the fishing bait 4 can include no hook loop 56 with the hook 70 directly connected to the rattle case 12, such as in FIG. 5. The line loop 52 can also be directly connected to the case 12.

The fishing bait 4, including the rattle 10 and housing 30, can have many different appearances, as shown in FIGS. 1, and 8-11, with continuing reference to FIGS. 2-7. The housing 30 can include many configurations and/or different attachments, such as soft bodies 44, feathers 86, frills 88, legs 84, spoons, beads, tails, claws, and others. In some embodiments, the housing 30 can be a soft body 44 for example a worm or lizard, with the rattle 10 insertable into, or incorporated within, the housing 30. In this embodiment, the housing 30 could be used in connection with a separate hook 70. Many different variations are available for the legs 84, such as frills 88 or singular components, solid or jointed pieces, and flexible or stiff pieces.

The fishing bait 4 can be configured for different sized bait, different swimming motions, different rates of sinking or floating, different appearances and shapes, different colors and color combinations, and different casting weights. There are many means to include the rattle 10 in the fishing bait 4, some of which have been described above. These can include integrally including the rattle 10 in the fishing bait 4. Alternatively, the wrap 24 could be used as the housing 30, so the shape of the rattle 10 was visible. The rattle 10 could be in a wrap 24 with or without a housing 30, with a hook 70 connected rigidly to the rattle 10, the hook 70 connected to the rattle 10 with a swivel 66, or the hook 70 connected to a separate component of the fishing bait 4. The wide variety of fishing baits 4 provides a fisherman with many options.

While the invention has been described with respect to a limited number of embodiments, those skilled in the art, having the benefit of this disclosure, will appreciate that other embodiments can be devised which do not depart from the scope of the invention as disclosed here. Accordingly, the scope of the invention should be limited only by the attached claims.

I claim:

1. A rattling weight for use in a fishing bait comprising:
A rigid case having at least one perforation in the case;
A rigid ringer positioned within the case; and
A polymeric wrap completely enveloping the case, where the polymeric wrap is waterproof, and where the weight has a specific gravity greater than one gram per cubic centimeter.

2. The rattling weight of claim 1 where the case is of unitary construction.

3. The rattling weight of claim 1 further comprising a fishing bait, where the fishing bait includes a housing and a hook connected together, and where the rattling weight is positioned within the housing.

4. A rattle for use in a fishing bait comprising:
a case having at least one perforation in the case;
a ringer positioned within the case; and
a wrap enveloping the case.

5. The rattle of claim 4 where the wrap completely covers the case of the rattle.

6. The rattle of claim 4 where the rattle has a density greater than one gram per cubic centimeter.

7. The rattle of claim 4 where the case is rigid and the ringer is rigid.

8. The rattle of claim 4 where the rattle is substantially waterproof.

9. The rattle of claim 4 where the case is of unitary construction.

10. The rattle of claim 4 where the wrap is polymeric.

11. The rattle of claim 4 further comprising a housing, where the rattle is positioned within the housing.

12. The rattle of claim 11 further comprising a hook, where the hook penetrates the housing.

13. A rattling weight for use with a fishing bait comprising:
a perforated, rigid case;
a rigid ringer positioned within the case;
a wrap enveloping the case, where the rattling weight has a specific gravity of more than one gram per cubic centimeter; and
a fishing bait including a housing, where the rattling weight is positioned within the housing.

14. The rattling weight of claim 13 where the fishing bait further comprises a hook having a point, the rattle including means for positioning the hook point within 10 centimeters of the housing.

15. The rattling weight of claim 13 where the housing has a frog shape.

16. The rattling weight of claim 13 where the wrap is polymeric.

17. The rattling weight of claim 13 where the rattle is substantially waterproof.

18. The rattling weight of claim 13 where the ringer is of a different material than the case.

19. The rattling weight of claim 13 where the ringer is rigid.

20. The rattling weight of claim 13 where the wrap completely covers the case.
